(19) United States
(12) Patent Application Publication
(10) Pub. No.: US 2026/0369832 A1
(43) Pub. Date: Nov. 19, 2026

(54) CELL FOR ELECTRIC BATTERY AND METHOD FOR MANUFACTURING SAME

(71) Applicant: VERKOR, Grenoble (FR)

(72) Inventors: Christophe MILLE, Grenoble (FR); Adrien CHALUMEAU, Grenoble (FR); Bruno DELOBEL, Grenoble (FR)

(21) Appl. No.: 19/133,559

(22) PCT Filed: Dec. 5, 2023
(86) PCT No.: PCT/IB2023/062234

§ 371 Date: Jun. 16, 2025

(30) Foreign Application Priority Data
Dec. 5, 2022 (FR) FR2212793

(51) Int. Cl. H01M 50/538; H01M 4/70; H01M 10/04; H01M 50/528; H01M 50/533

(52) U.S. Cl. CPC H01M 50/538; H01M 4/70; H01M 10/0431; H01M 50/528; H01M 50/533

(57) ABSTRACT

The invention relates to an electric battery cell (1) for an electrically propelled vehicle, the cell (1) comprising at least one successive stack of a sheet: a first electrode (2) including a first active portion (9) coated with an active material and a first inactive portion (10), a first insulating separator (3), a second electrode (4) including a second active portion (11) coated with an active material and a second inactive portion (12), a second insulating separator (5), the at least one stack being wound onto itself about a central axis (8) so as to form a cylinder, the cell (1) comprising a first end (13) from which the first inactive portion (10) projects, in which cell (1) the first inactive portion (10) includes at least two cut-outs (14) so as to form bendable current-collection tabs (16) between the cut-outs (14).

### TECHNICAL FIELD OF THE INVENTION

The invention relates to the field of electric batteries for electric motor vehicles. In particular, the invention relates to electric battery cells. More specifically, the invention relates to cylindrical cells.

### TECHNICAL BACKGROUND

Cylindrical electric battery cells are increasingly used in the automotive industry.

The advantage of cylindrical cells lies in their ability to store a large amount of energy in a small volume. They therefore take up less space in the vehicle for a given energy storage capacity.

The energy storage capacity of a cylindrical cell depends on its diameter. Thus, the larger the diameter of a cylindrical cell, the greater its energy storage capacity.

Cylindrical cells are manufactured by winding, around a mandrel, a consecutive stack of at least:
a positive electrode sheet,
an insulating separator sheet,
a negative electrode sheet,
a insulating separator sheet.

Along the electrode sheets, current-collection tabs are added and then attached to said positive and negative electrode sheets. Although automated, this operation is particularly time-consuming and slows down the speed of production of cylindrical cells. In addition, attachment and/or contact defects between tabs and electrodes can reduce the performance of cylindrical cells, or even cause short circuits.

To overcome these problems, some manufacturers have proposed doing away with tabs added and then attached to the electrodes.

One such solution is to make cut-outs directly in the electrode sheets to form current-collection tabs before winding them around a rotating mandrel. After winding, these tabs are bent and brought into contact with an added current collector.

One drawback of this method is that it requires a large number of cut-outs to be made in a cutting operation carried out prior to winding around the mandrel. As a result, cell production speeds are slowed down by the large number of cut-outs that have to be made.

Another drawback of this method is that the current-collection tabs can be damaged during winding around the mandrel, as the tabs are thin and can easily be damaged during handling operations.

Another drawback of this method is the difficulty in bending the tabs, due in part to the large number thereof. In addition, attaching the tabs in the bent position is time-consuming and technically difficult when the goal is to achieve industrial production speeds.

The invention therefore aims to solve the above-mentioned problems.

### SUMMARY OF THE INVENTION

To this end, the invention first provides an electric battery cell for an electrically propelled vehicle, said cell comprising at least one consecutive stack of a sheet:
of a first electrode comprising a first active portion coated with an active material and a first inactive portion,
of a first insulating separator,
of a second electrode comprising a second active portion coated with an active material and a second inactive portion,
of a second insulating separator,
   said at least one stack being wound onto itself about a central axis so as to form a cylinder, said cell comprising a first end from which the first inactive portion projects, in which cell the first inactive portion comprises at least two cut-outs so as to form bendable current-collection tabs between said cut-outs, said cell comprising a first current collector comprising an inner face arranged facing the electrode and an outer face opposite the inner face, said current collector being provided with at least a first bearing portion projecting from the inner face along the central axis, said first bearing portion being intended to come into contact with the current-collection tabs and hold said bendable current-collection tabs in the bent position,
   in which cell the bearing portion extends over a length between a proximal end located on the same side as the central axis and a distal end opposite the proximal end and located on the side of a periphery of the first current collector, the length being measured along a radial axis passing through the bearing portion and intersecting and being substantially perpendicular to the central axis,
   in which cell the bearing portion has a height, measured from the inner face to a contact face and along the central axis, said height decreasing along the length from the periphery toward the central axis.

The production of such cells can be carried out at industrial speeds, as the number of cut-outs is reduced, without any loss of cell efficiency, since conductivity is maintained at acceptable levels. Bending is made easier by the smaller number of current-collection tabs compared with current cells. As a result, the scrap rate is significantly lower. In addition, the particular shape of the bearing portion ensures that the current-collection tabs bend in the direction of the central axis, thereby facilitating bending in the right direction simply by positioning the current collector. In other words, there is no need for pre-bending operations (which precede the positioning of the current collector using an additional tool, for example) on the current-collection tabs. Furthermore, the formation of a disordered cluster of metal in the region of the current-collection tabs is avoided.

Various additional features can be provided alone or in combination:
said cell comprises a second end opposite the first end along the central axis, from which second end the second inactive portion projects, in which cell the second inactive portion comprises at least two cut-outs so as to form current-collection tabs between said cut-outs, said cell comprising a second current collector provided with at least a second bearing portion intended to come into contact with the bendable current-collection tabs and hold them in the bent position;
the current-collection tabs are bent over one another from a periphery of the cell toward the central axis;
the at least first bearing portion of the first current collector is secured to the current-collection tabs of the first electrode and the at least second bearing portion of the second current collector is secured to the current-collection tabs of the second electrode;
said cell comprises, at each end, a plurality of bendable current-collection tab portions which are distinct from one another, and the first and second current collectors comprise a plurality of bearing portions which are distinct from one another, each bearing portion being intended to come into contact with a current-collection tab portion in order to hold the current-collection tabs in the bent position;
the current collectors are metal disks comprising an inner face arranged facing the electrode and an outer face opposite the inner face, in which cell the at least one bearing portion projects from the inner face along the central axis;
the cut-outs extend over a length substantially equal to the length (of the bearing portions);
the inner face is arranged at a distance from the electrodes;
the second current collector is substantially identical to the first current collector;

Second, the invention provides an electric battery comprising a plurality of cells as described above and connectors intended for connecting said cells to one another.

Third, the invention provides a method for manufacturing a cell as described above, the method comprising:
an operation of supplying a sheet of a first electrode comprising a first active portion and a first inactive portion,
an operation of supplying a sheet of a first insulating separator,
an operation of supplying a sheet of a second electrode comprising a second active portion and a second inactive portion,
an operation of supplying a sheet of a second insulating separator,
an operation of consecutively stacking the first electrode, the first insulating separator, the second electrode, and the second insulating separator so as to form a stack in which the first electrode and the second electrode are laterally offset with respect to one another so that the first inactive portion and the second inactive portion project at least partly out of the stack,
an operation of winding the stack onto itself so as to form substantially a cylinder, said cylinder comprising a first end from which projects, beyond the stack, the first inactive portion and a second end from which projects, beyond the stack, the second inactive portion,
an operation of cutting, subsequent to the winding operation, the first inactive portion and the second inactive portion, so as to form current-collection tabs,
an operation of arranging the first current collector and the second current collector on the first end and on the second end, respectively, such that the at least one bearing portion comes into contact with the at least one current-collection tab portion so as to bend the current-collection tabs.

The method comprises an operation of welding the bearing portions of the current collectors to the current-collection tabs.

### BRIEF DESCRIPTION OF THE FIGURES

Further features and advantages of the invention will become apparent from the following detailed description, for the understanding of which reference is made to the accompanying drawings, in which:

FIG. 1 is a schematic cross section of a portion of a cylindrical cell according to the invention;

FIG. 2 is a schematic view from above of a current collector according to the invention;

FIG. 3 is a schematic cross section of the current collector shown in FIG. 2;

FIG. 4 is a schematic view from above of a current collector according to the invention;

FIG. 5 is a schematic cross section of the current collector shown in FIG. 4;

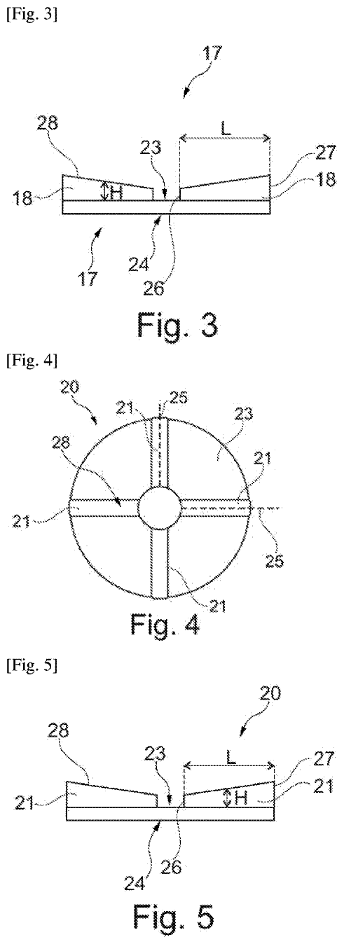

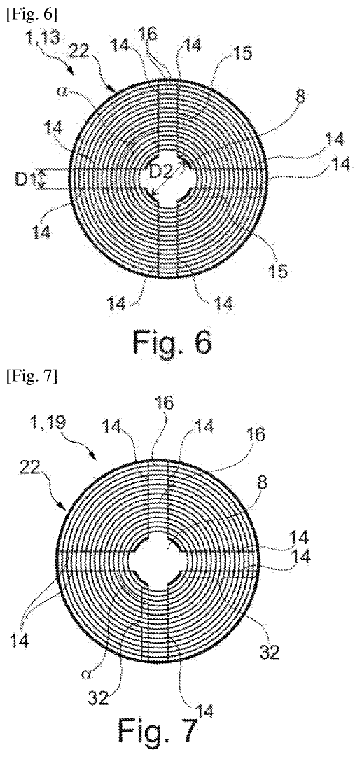

FIG. 3 is a schematic depiction of one end of a cell according to the invention;

FIG. 7 is a schematic representation of another end of the cell according to the invention.

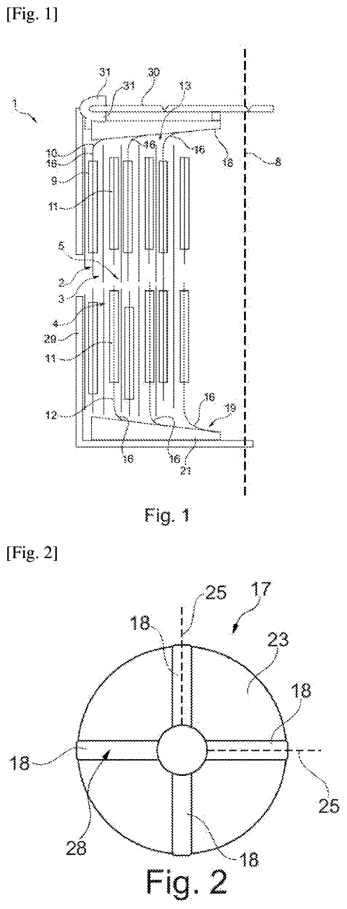

### DETAILED DESCRIPTION OF THE INVENTION

[FIG. 1] shows an electric battery cell 1. The cell 1 is intended to supply an electrically propelled vehicle with power. The cell 1 comprises at least one consecutive stack of a sheet:
of a first electrode 2,
of a first insulating separator 3,
of a second electrode 4,
of a second insulating separator 5.

The stack is wound onto itself about a central axis 8 so as to form a cylinder.

The first electrode 2 comprises a first active portion 9, which is coated with an active material, and a first inactive portion 10, which is not coated with any active material. Thus, the first inactive portion 10 is a metal, for example aluminum or copper.

The second electrode 4 comprises a second active portion 11, which is coated with an active material, and a second inactive portion 12, which is not coated with any active material. Thus, the second inactive portion 12 is a metal, for example aluminum or copper.

The cell 1 comprises a first end 13. The first inactive portion 10 projects from this first end 13. What is meant by “projects” is that the first inactive portion 10 extends at least partly, along the central axis 8, beyond the separators 3, 5.

As can be seen in FIGS. 6 and 7, the first inactive portion 10 comprises at least two cut-outs 14. In the embodiment shown in the drawings, the first inactive portion 10 comprises eight cut-outs 14 forming four first tab portions 15. The cut-outs 14 allow bendable current-collection tabs 16 to be formed.

The cell 1 comprises a first current collector 17. The first current collector 17 comprises at least a first bearing portion 18. The first bearing portion 18 is intended to come into contact with the bendable current-collection tabs 16 and hold them in the bent position.

The production of such cells 1 can be carried out at industrial speeds, as the number of cut-outs 14 is reduced, without any loss of efficiency in the cell 1, since conductivity is maintained at acceptable levels. Bending is made easier by the smaller number of current-collection tabs 14 compared with current cells. As a result, the scrap rate is significantly lower.

Advantageously, the cell 1 comprises a second end 19, opposite the first end 13 along the central axis 8. The second inactive portion 12 projects from this second end 19. What is meant by “projects” is that the second inactive portion 12 extends, along the central axis 8, beyond the separators 3, 5.

Advantageously, the second inactive portion 12 comprises at least two cut-outs 14 forming current-collection tabs 16 between said cut-outs 14. In the embodiment shown in the drawings, the second inactive portion 12 comprises eight cut-outs 14 forming four second tab portions 32.

Advantageously, the cell 1 comprises a second current collector 20 provided with at least a second bearing portion 21. The second bearing portion 21 is intended to come into contact with the bendable current-collection tabs 16 and hold them in the bent position.

It is advantageous for the second end 19 to be identical to the first end 13 for the sake of uniformity of production. This simplifies the method for manufacturing the cell 1.

Advantageously, the current-collection tabs 16 are bent over one another, as can be seen in [FIG. 1]. They are bent from a periphery 22 of the cell 1 toward the central axis 8.

It is advantageous for the current-collection tabs 16 to be bent in this direction, as this avoids the risk of short circuits.

Advantageously, the first bearing portions 18 of the first current collector 17 are secured to the current-collection tabs 16 of the first electrode 2. Advantageously, the second bearing portions 21 of the second current collector 20 are secured to the current-collection tabs 16 of the second electrode 4. They are secured by welding for example.

By securing only the bearing portions 18, 21 to the current-collection tabs 16, the number of welds is reduced while maintaining acceptable electrical conductivity. This allows production speeds to be improved.

Advantageously, the first current collector 17 comprises four first bearing portions 18 which are distinct from one another. Each first bearing portion 18 is intended to come into contact with a first current-collection tab portion 15 and hold the current-collection tabs 16 in the bent position.

Advantageously, the second current collector 20 comprises four second bearing portions 21 which are distinct from one another. Each second bearing portion 21 is intended to come into contact with a second current-collection tab portion 32 and hold the current-collection tabs 16 in the bent position.

Advantageously, the first and second current collectors 17, 20 take the form of a metal disk. The metal disk comprises an inner face 23 arranged facing the electrode 2, 4 and an outer face 24 opposite the inner face 23. The bearing portions 18, 21 project from the inner face 23 along the central axis 8.

Such bearing portions 18, 21 ensure contact with the current-collection tabs 16.

Advantageously, the first current collector 17 and the second current collector 20 are substantially identical.

Advantageously, each bearing portion 18, 21 extends over a length L. The length L is measured along a radial axis 25 passing through the bearing portion 18, 21. The radial axis 25 is substantially perpendicular to the central axis 8. The radial axis 25 intersects central axis 8. The length L is measured between a proximal end 26 located on the same side as the central axis 8 and a distal end 27 opposite the proximal end 26 along the radial axis 25 substantially perpendicular to the central axis 8. The distal end 27 is located on the same side as the periphery 22 of the cell 1. The cut-outs 14 extend over a length that is substantially equal to the length L.

It should be noted that there are as many radial axes 25 as there are bearing portions 18, 21. In this case, each bearing portion 18, 21 is associated with its radial axis 25 passing through said bearing portion 18, 21, substantially perpendicular to the central axis 8 and intersecting said central axis 8.

As the length of the bearing portions 18,21 and that of the cut-outs 14 are substantially equal, contact is optimal and conductivity is maintained at an acceptable level.

Advantageously, two adjacent cut-outs are spaced apart by a distance D1 less than or equal to 80% of an inner diameter D2. The inner diameter D2 corresponds to the outer diameter of the winding mandrel.

Such a distance D1 facilitates the bending of the current-collection tabs 16.

Advantageously, the bearing portions 18, 21 of the current collectors comprise a contact face 28 that is intended to come into contact with the current-collection tabs 16.

This allows optimal conductivity to be maintained.

Advantageously, the bearing portion 18, 21 has a height H measured in a direction parallel to the central axis 8. The height H is measured from the inner face 23 to the contact face 28 of the bearing portions. The height H decreases along the length L from the periphery 22 of the cell 1 toward the central axis 8.

This ensures that the current-collection tabs 16 bend in the direction of the central axis 8, thereby facilitating bending in the right direction simply by positioning the current collectors 17, 20. In other words, there is no need for pre-bending operations (which precede the positioning of the current collector using an additional tool, for example) on the current-collection tabs. Furthermore, the formation of a disordered cluster of metal in the region of the current-collection tabs is avoided.

Advantageously, the inner face 23 of the first current collector 17 and of the second current collector 20 are arranged at a distance from the first electrode 2 and from the second electrode 4, respectively. Thus, there is no contact between the inner face 23 and the inactive portions of the electrodes.

Advantageously, the first tab portions 15 are arranged at 90° to one another. Thus, the first tab portions 15 form an angle a of 90° with one another.

Advantageously, the second tab portions 32 are arranged at 90° to one another. Thus, the second tab portions 32 form an angle a of 90° with one another.

This allows better conductivity by reducing the distance traveled by electrons through the electrode sheets. This improves cell performance.

As can be seen in [FIG. 1], the cell is assembled by inserting the assembly comprising the wound stack and the current collectors into a rigid cylindrical capsule 29. The second current collector 20, which is the negative pole, is in contact with the cylindrical capsule 29, and so the cylindrical capsule 29 is negatively biased. Conversely, the first current collector 17 is positively biased and is not in direct contact with the cylindrical capsule 29. The cell 1 comprises a cover 30 which is added and attached to the first current collector 17 and is therefore positively biased. As can be seen in [FIG. 1], insulating elements 31 are arranged between the first current collector 17 and the cylindrical capsule 29. Further insulating elements 31 are arranged between the cover 30 and the cylindrical capsule 29. These insulating elements 31 prevent short circuits.

The invention also relates to an electric battery (not shown in the drawings) comprising a plurality of cells 1. The battery comprises connectors intended for interconnecting the cells.

In the following, a method for manufacturing the cell will be described.

The method comprises an operation of supplying:
a sheet of a first electrode comprising a first active portion and a first inactive portion,
a sheet of a first insulating separator,
a sheet of a second electrode comprising a second active portion and a second inactive portion,
a sheet of a second separator.

The method comprises an operation of consecutively stacking the first electrode, the first insulating separator, the second electrode and the second insulating separator. The stacking is carried out such that:
at the first end, the first inactive portion projects beyond the stack, and
at the second end, the second inactive portion projects beyond the stack.

The method comprises an operation of winding the stack onto itself to form substantially a cylinder. Thus, at the first end of the cylinder, the first inactive portion projects from the stack, while at the second end of the cylinder, the second inactive portion projects from the stack.

The method comprises a cutting operation, subsequent to the winding operation. The cut-out allows current-collection tabs to be formed. In the embodiment shown in the drawings, eight cut-outs are made to form four current-collection tab portions on each end of the cell.

The method comprises an operation of arranging the first current collector and the second current collector on the first end and on the second end, respectively. This arranging operation is carried out such that each bearing portion comes into contact with a current-collection tab portion. The contact inclines the current-collection tabs toward the central axis.

Such cells can be produced at industrial speeds, as the number of cut-outs is more reasonable without any loss of cell efficiency. In addition, the current-collection tabs are not damaged, as the cut-outs are made after winding, not before winding. Bending is also made easier by the smaller number of current-collection tabs compared with current cells. As a result, the scrap rate is significantly lower.

Advantageously, the method comprises an operation of welding the bearing portions to the current-collection tabs, thereby securing the current collectors to said current-collection tabs.

1. An electric battery cell (1) for an electrically propelled vehicle, said cell (1) comprising at least one consecutive stack of a sheet:
of a first electrode (2) comprising a first active portion (9) coated with an active material and a first inactive portion (10),
of a first insulating separator (3),
of a second electrode (4) comprising a second active portion (11) coated with an active material and a second inactive portion (12),
of a second insulating separator (5),
said at least one stack being wound onto itself about a central axis (8) so as to form a cylinder, said cell (1) comprising a first end (13) from which the first inactive portion (10) projects, in which cell (1) the first inactive portion (10) comprises at least two cut-outs (14) so as to form bendable current-collection tabs (16) between said cut-outs (14), said cell comprising a first current collector (17) comprising an inner face (23) arranged facing the electrode and an outer face (24) opposite the inner face (23), said current collector being provided with at least a first bearing portion (18) projecting from the inner face (23) along the central axis (8), said first bearing portion (18) being intended to come into contact with the current-collection tabs (16) and hold said bendable current-collection tabs (16) in the bent position,
in which cell the bearing portion (18) extends over a length (L) between a proximal end (26) located on the same side as the central axis (8) and a distal end (27) opposite the proximal end (26) and located on the side of a periphery (22) of the first current collector (17), the length (L) being measured along a radial axis (25) passing through the bearing portion (18) and intersecting and being substantially perpendicular to the central axis (8),
in which cell the bearing portion (18) has a height (H), measured from the inner face (23) to a contact face (28) and along the central axis (8), said height (H) decreasing along the length (L) from the periphery (22) toward the central axis (8).

2. The cell (1) as claimed in claim 1, wherein said cell comprises a second end (19) opposite the first end (13) along the central axis (8), from which second end (19) the second inactive portion (12) projects, in which cell (1) the second inactive portion (12) comprises at least two cut-outs (14) so as to form current-collection tabs (16) between said cut-outs (14), said cell (1) comprising a second current collector (20) provided with at least a second bearing portion (21) intended to come into contact with the bendable current-collection tabs (16) and hold them in the bent position.

3. The cell (1) as claimed in claim 1, wherein the current-collection tabs (16) are bent over one another from a periphery (22) of the cell (1) toward the central axis (8).

4. The cell (1) as claimed in claim 2, wherein the at least first bearing portion (18) of the first current collector (17) is secured to the current-collection tabs (16) of the first electrode (2) and the at least second bearing portion (21) of the second current collector (20) is secured to the current-collection tabs (16) of the second electrode (4).

5. The cell (1) as claimed in claim 4, wherein said cell comprises, at each end (13, 19), a plurality of bendable current-collection tab portions (15, 32) which are distinct from one another, and the first and second current collectors (17, 20) comprise a plurality of bearing portions (18, 21) which are distinct from one another, each bearing portion (18, 21) being intended to come into contact with a current-collection tab portion (15, 32) in order to hold the current-collection tabs (16) in the bent position.

6. The cell as claimed in claim 4, wherein the current collectors (17, 20) are metal disks comprising an inner face (23) arranged facing the electrode (2, 3) and an outer face (24) opposite the inner face (23), in which cell (1) the at least one bearing portion (18, 21) projects from the inner face (23) along the central axis (8).

7. The cell (1) as claimed in claim 6, wherein the cut-outs (14) extend over a length substantially equal to the length (L).

8. The cell (1) as claimed in claim 6, wherein the inner face (23) is arranged at a distance from the electrodes (2, 4).

9. The cell (1) as claimed in claim 2, wherein the second current collector (20) is substantially identical to the first current collector (17).

10. An electric battery comprising a plurality of cells (1) as claimed in claim 1 and connectors intended for connecting the cells to one another.

11. A method for manufacturing a cell as claimed in claim 1, the method comprising:
an operation of supplying a sheet of a first electrode comprising a first active portion and a first inactive portion,
an operation of supplying a sheet of a first insulating separator,
an operation of supplying a sheet of a second electrode comprising a second active portion and a second inactive portion,
an operation of supplying a sheet of a second insulating separator,
an operation of consecutively stacking the first electrode, the first insulating separator, the second electrode, and the second insulating separator so as to form a stack in which the first electrode and the second electrode are laterally offset with respect to one another so that the first inactive portion and the second inactive portion project at least partly out of the stack,
an operation of winding the stack onto itself so as to form substantially a cylinder, said cylinder comprising a first end from which projects, beyond the stack, the first inactive portion and a second end from which projects, beyond the stack, the second inactive portion,
an operation of cutting, subsequent to the winding operation, the first inactive portion and the second inactive portion, so as to form current-collection tabs,
an operation of arranging the first current collector and the second current collector on the first end and on the second end, respectively, such that the at least one bearing portion comes into contact with the at least one current-collection tab portion so as to bend the current-collection tabs.

12. The method as claimed in claim 11, wherein the method comprises an operation of welding the bearing portions of the current collectors to the current-collection tabs.
